(19) United States
(12) Patent Application Publication
(10) Pub. No.: US 2019/0120479 A1
(43) Pub. Date: Apr. 25, 2019

(54) MOBILE DEVICE CASE WITH LIGHTING AND STAND ELEMENTS

(71) Applicant: Starz Plus LLC, New York, NY (US)

(72) Inventor: Nikki HASKELL, Los Angeles, CA (US)

(21) Appl. No.: 15/790,655

(22) Filed: Oct. 23, 2017

(51) Int. Cl. F21V 33/00; F21L 4/02; H02J 7/00

(52) U.S. Cl. CPC F21V 33/0052; F21L 4/02; H04W 4/008; H02J 7/0045; H02J 2007/0049; H02J 7/0047

(57) ABSTRACT

A mobile device case includes a first case member and a second case member releasably engaged therewith, the first and second case members being dimensioned to receive a mobile device therebetween. The first case member includes a reflective surface. A stand is rotatably attached to the mobile device case. The stand has at least one telescoping segment which allow the stand to further be used as a selfie stick. The stand further includes a Bluetooth enabled toggle element to cooperate with the mobile device camera function.

### BACKGROUND OF THE INVENTION

The present invention relates to cases for mobile devices, and more particularly mobile device cases including lighting features and adjustable stands.

There are millions—if not billions—of mobile devices used in the world today. Mobile devices, also referred to as handhelds or handheld devices, are computer-enabled electronic devices, which are generally small enough to be carried around by hand or in a pocket or purse. Commonly used mobile devices include, but are not limited to, phones, tablets, Personal Digital Assistants (PDAs), cameras, gaming devices, personal navigation devices, audio players, multimedia players and the like. The use of mobile devices not only varies, but continues to grow day by day. But most, if not all, mobile devices in use today include a camera that allows a user to take a self-photograph or “selfie.” With the explosion of social media, users typically take selfies and share them with their followers via platforms such as Twitter, Instagram, Facebook and the like.

Users of mobile devices typically carry such devices wherever they go—at work, play and home—and often prefer to use a case or other such device to protect and improve the aesthetic value of the mobile devices. Unfortunately, most cases for mobile devices do not include a stand that allows upright positioning of the mobile device to take selfies or to display photos or videos. Most such cases also do not include additional features that would enhance the background and overall appearance of a selfie. Further, most such cases do not include Bluetooth technology for cooperation with the camera function of mobile devices to facilitate the taking of selfies. Most cases additionally do not facilitate charging of a case battery and a Bluetooth battery independent from charging of the internal mobile device battery. As such, there are clear needs for improved cases for mobile devices. The present invention fulfills these needs and provides further related advantages, as described herein.

### BRIEF SUMMARY OF THE INVENTION

Briefly stated, one aspect of the present invention is directed to a mobile device case comprising a first case member having a front surface and at least one opening; a second case member releasably engageable with the first case member, the first and second case members being dimensioned to receive a mobile device therebetween, the second case member including a case battery, a case recharging port in electrical contact with the case battery, and at least one slot having a top end and a bottom end; a shaft disposed in the slot, the shaft being configured to translate relative to the slot; and a stand rotatably attached to the shaft, the stand comprising a rotating segment engaging the shaft, at least one telescoping segment extendable from and nestable within the rotating segment, and a grippable segment extending from and nestable within the at least one telescoping segment, the grippable segment comprising a toggle element wirelessly connectable to the mobile device, a grip battery for powering the toggle element, and a grip recharging port in electrical contact with the grip battery.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a front perspective view of a preferred embodiment of a mobile device case according to the present invention;

FIG. 2 is a front elevational view of a first member of the mobile device case shown in FIG. 1;

FIG. 3 is a rear elevational view of the first case member shown in FIG. 2;

FIG. 4 is an enlarged fragmentary rear and bottom perspective view of a portion of the first case member shown in FIG. 2;

FIG. 5 is a front elevational view of a second case member of the mobile device case shown in FIG. 1;

FIG. 6 is a rear elevation view of the second case member shown in FIG. 5 with a stand in a stowed position;

FIG. 7 is a left side elevational view of the second case member shown in FIG. 5;

FIG. 8 is an enlarged fragmentary rear and bottom perspective view of a portion of the second case member shown in FIG. 5;

FIG. 9 is a front and top perspective view of a shaft of the mobile device case shown in FIG. 1;

FIG. 10 is a front and top perspective view of an assembled mobile device case according to the present invention with a stand in an extended position;

FIG. 11 is a bottom plan view of the stand and second case member shown in FIG. 10 in a retracted position;

FIG. 12 is a front and top perspective view of the mobile device case shown in FIG. 10 with the stand in a retracted; and

FIG. 13 is a rear elevational view of the mobile device case shown in FIG. 1 with a dual-headed charging cable.

### DETAILED DESCRIPTION OF THE INVENTION

Certain terminology is used in the following description for convenience only and is not limiting. The words “lower” and “upper” designate directions in the drawings to which reference is made. Unless specifically set forth herein, the terms “a,” “an,” and “the” are not limited to one element but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

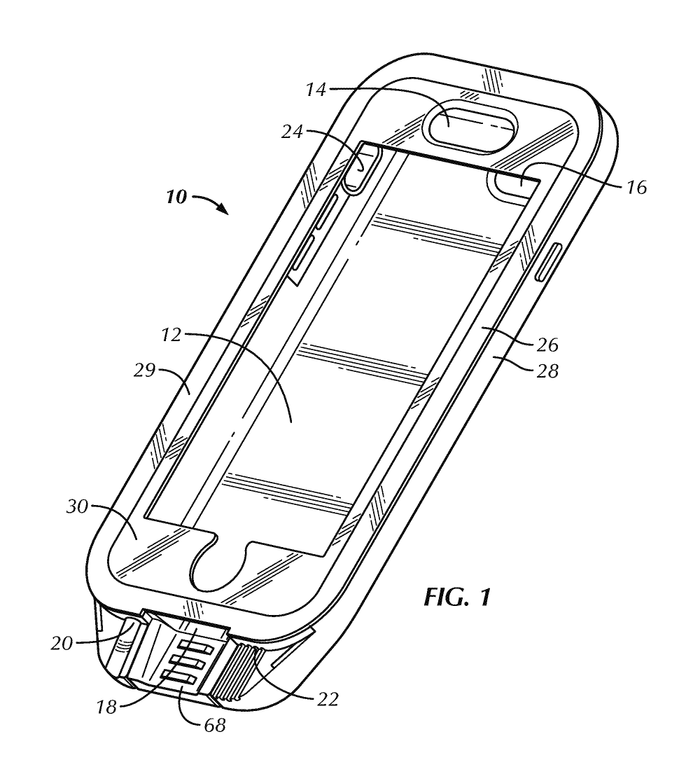

Referring to FIG. 1, in a preferred embodiment, the present invention comprises a mobile device case 10 for protection of a mobile device, in the present embodiment a mobile telephone (not shown). The mobile device case 10 includes additional features that enhance the appearance of photographs taken with the mobile device. The case 10 also includes additional features that facilitate taking photographs, particularly selfies, with the mobile device. The case 10 is particularly suited with mobile devices such as phones, tablets, Personal Digital Assistants (PDAs), cameras, gaming devices, personal navigation devices, audio players, multimedia players and the like. Such devices include, but are not limited to, those sold and/or manufactured by Samsung, Apple, Sony, LG, and Nokia.

The mobile device case 10 shown in FIG. 1 is particularly suited for use with Apple iPhone devices. The case 10 includes various openings that align with complementarily positioned mobile device features. For example, the case 10 includes a screen opening 12 with a generally rectangular perimeter, a forward facing camera opening 14, a rearward facing camera opening 16, a power cord opening 18, a headphone opening 20, a speaker opening 22, and a mute button opening 24. The configuration and positioning of such openings as shown in the Figs., however, should not be construed as limiting. The mobile device cases 10 disclosed herein may include fewer or more openings with different configurations, depending on features included within the mobile device designated for use with the case 10.

The mobile device case 10, shown in FIGS. 1-6, includes a first case member 26 and a second case member 28, which are releasably secured to one another. The first and second case members 26, 28 are dimensioned to receive and, when secured to each other, to at least partially enclose a mobile device (not shown) therebetween.

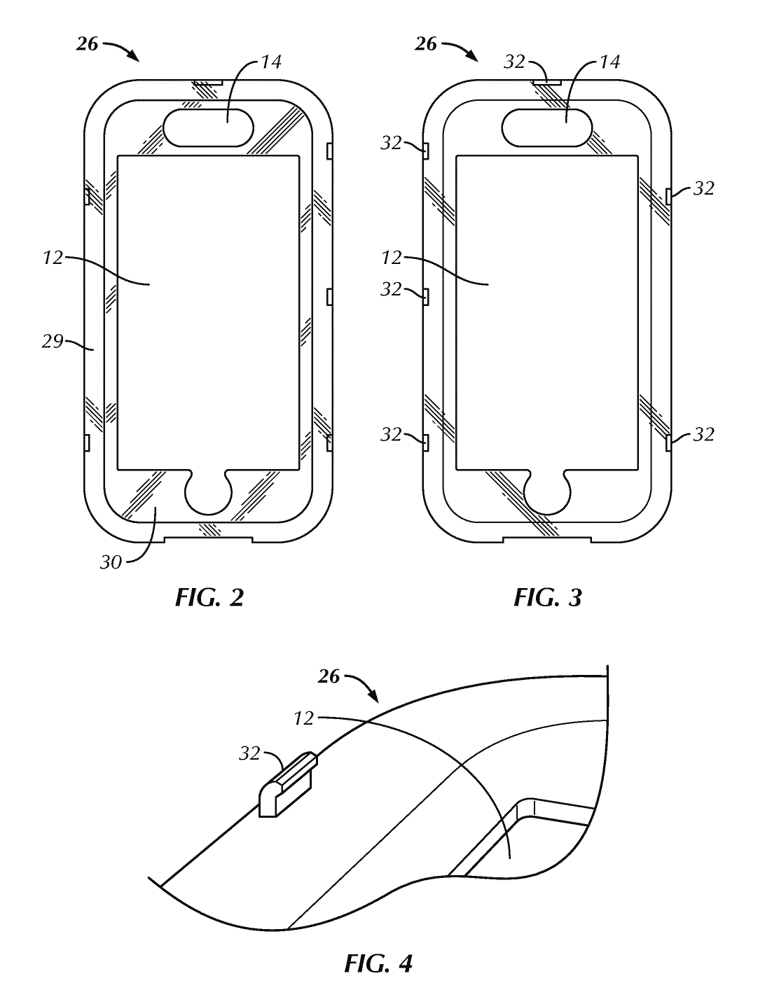

Referring now to FIGS. 2-4, the first case member 26 preferably includes a substantially contiguous mirror or mirror-like surface 30 positioned around the screen opening 12 on a front surface 29. The mirror-like surface 30 is comprised of or includes a reflective material having properties that allow one or more users of the mobile device to show one or more reflective images on the mobile device case 10. The first case member 26 is preferably made of a transparent elastomeric or polymeric material, but could be made from any suitable transparent material known in the art. The first case member 26 includes at least one locking element 32, and preferably several such locking elements 32 at spaced locations, each of which engages the second case member 28 for securing the case members 26, 28 together. The locking elements 32 may be one or more sliding tabs, hinges, hooks and latches, or any other suitable engagement type well understood in the art. The at least one locking element 32 is disposed opposite the mirror-like surface 30 on the front surface 29 of the first case member 26.

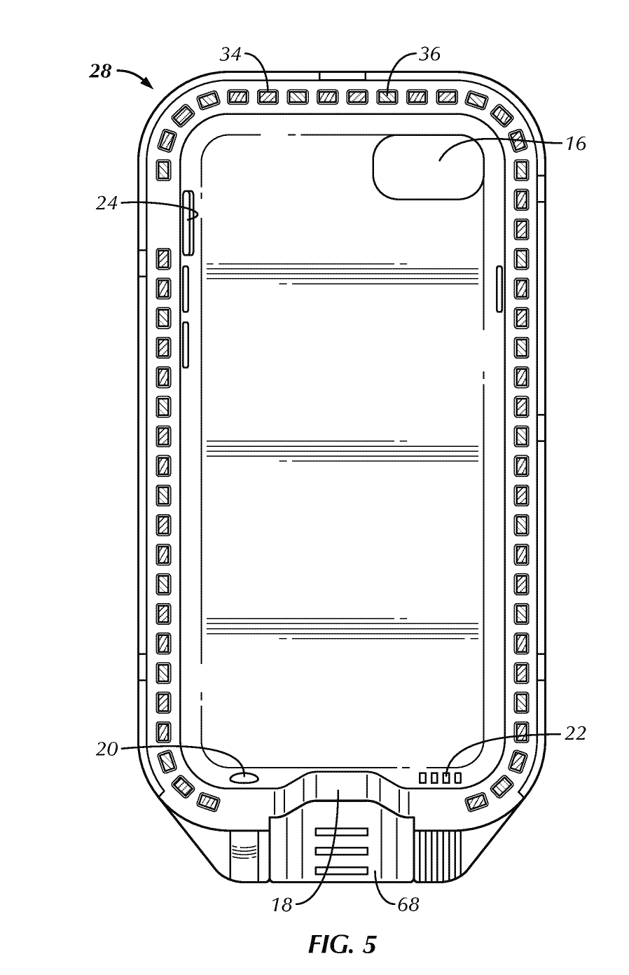

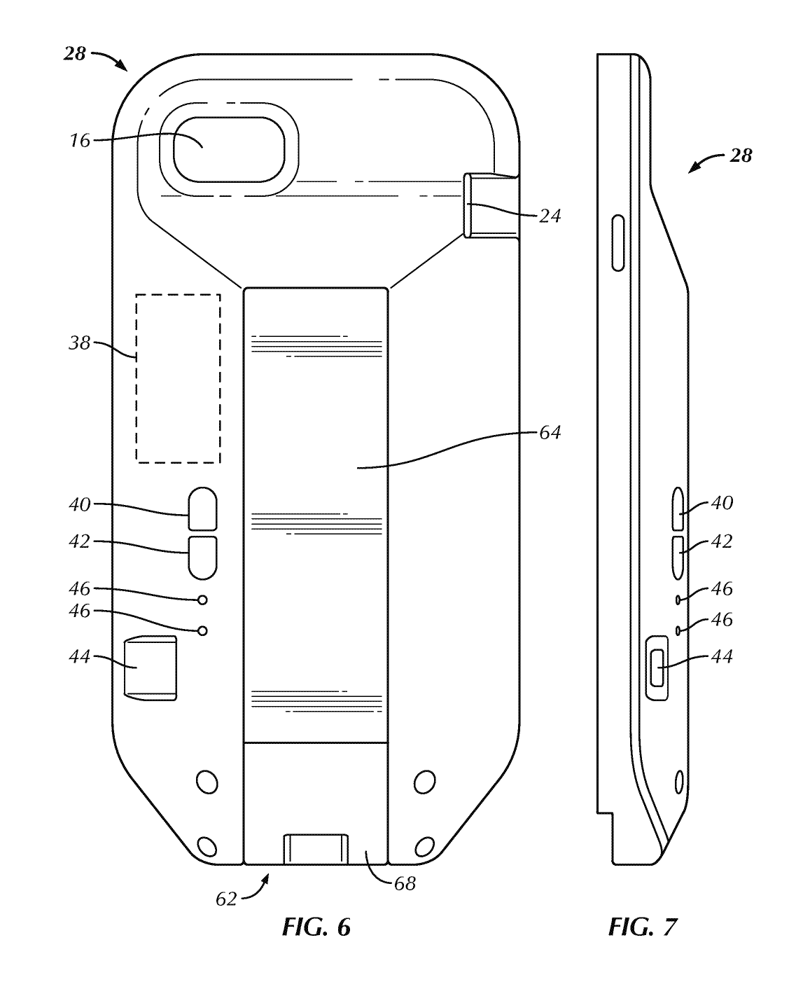

Referring now to FIGS. 5-8, the second case member 28 is preferably formed of a high impact polymeric material or combination of materials well known in the art. The second case member 28 includes at least one recess 34, and preferably a plurality of recesses 34 at spaced intervals around the periphery of the second case member 28 and disposed away from the first case member 26. At least one light 36 is disposed within each corresponding recess 34. The lights 36 allow the front of the mobile device case 10 to be illuminated. Illumination created by the lights 36 allows one or more users of the mobile device to enhance photographs taken with the mobile device. The lights 36 are each in electrical contact with a case battery 38 disposed within the interior of the second case member 28 (shown schematically in phantom lines in FIG. 6). The case battery 38 is preferably a rechargeable battery, and may be recharged by solar power, a power cord of the mobile device, or by a separate power source for the case such as a power cable or secondary battery. The lights 36 are also preferably in electrical contact with a light power on/off button 40 located on the rear surface of the second case member 28. The light power on/off button 40 controls the energy flow to the lights 36 and preferably controls the intensity or brightness of the lights 36 by allowing a low, medium, and high intensity setting for the lights 36. The light power on/off button 40 is long pressed to allow electricity to flow from the case battery 38 to the lights 36 and long pressed again to shut off the flow of electricity to the lights 36. When electricity is flowing, the light power on/off button 40 may be short pressed repeatedly to cycle through the low, medium, and high intensity settings. The lights 36 are preferably capable of emitting more than one color of light, and are in further electrical contact with a light mode button 42 also located on the rear surface of the second case member 28. The light mode button 42 also preferably controls the color of the light emitted by the lights 36. When the lights 36 are powered on by the light power on/off button, the light mode button 42 allows a user to cycle between two or more predetermined color combinations of the lights 36. The lights 36 are preferably light emitting diodes (LEDs), but may be incandescent bulbs, compact florescent lamp (CFL) bulbs, fluorescent bulbs, halogen bulbs, high intensity discharge (HID) bulbs, or any other type of suitable lightbulb that is well-known in the art.

The second case member 28 also includes a case recharging port 44 (see FIGS. 6-7). The case recharging port 44 is in electrical contact with the case battery 38 and is adapted to receive a charger therein to facilitate recharging of the case battery 38. The second case member 28 further includes at least one case battery indicator 46 (see FIG. 6), and in the present embodiment there are two case battery indicators 46 each in electrical contact with the case battery 38 and configured to convey charge data about the case battery 38 to the mobile device user. The case battery indicators 46 are preferably LEDs, and preferably each is capable of emitting first and second distinct colors in either a steady light or a blinking light. In the present embodiment, when the case battery 38 needs charging, a first case battery indicator 46 illuminates a flashing red light. When the case battery 38 is being charged, the first case battery indicator 46 illuminates a steady red light. When the case battery 38 is fully charged, the first case battery indicator 46 is not illuminated and a second case battery indicator 46 illuminates a steady blue light. Other indicator arrangements using alternatives may be employed.

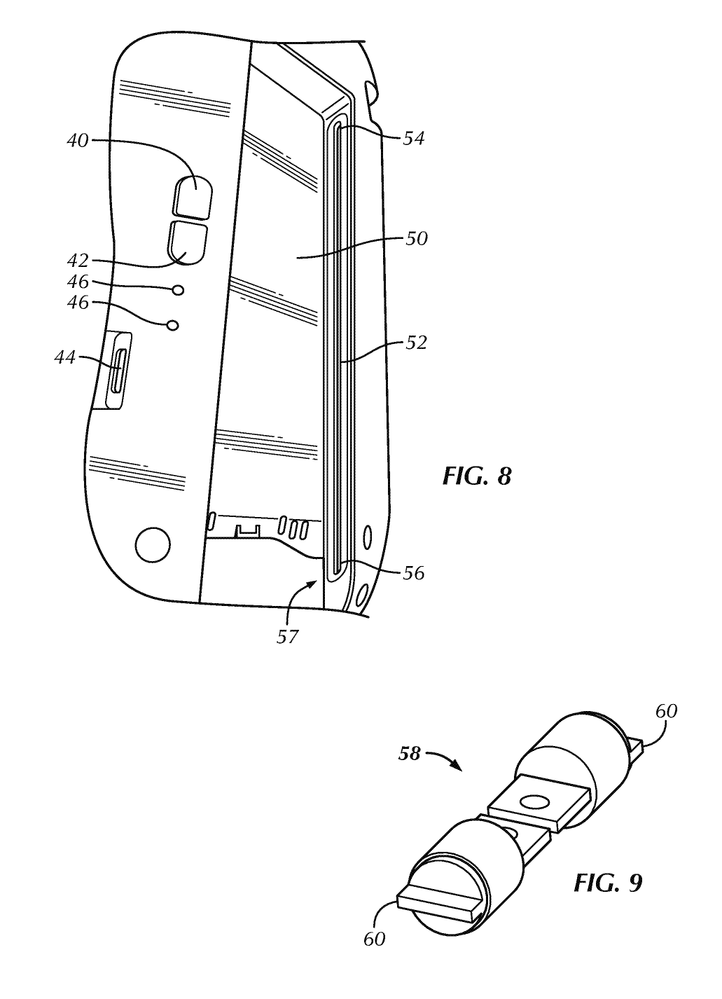

The second case member 28 also includes a stand receiver 50 and an interior slot 52 (see FIG. 8) disposed on an opposite side of the second case member 28 from the recesses 34. The stand receiver 50 forms an open-ended trench along the rear surface of second case member 28. The slot 52 is disposed on a wall of the stand receiver 50 and is substantially parallel to the stand receiver 50. The slot 52 further includes a top end 54 and a bottom end 56 disposed opposite the top end 54. The second case member 28 also includes a second slot (not shown) which is disposed on an opposite wall of the stand receiver 50 from slot 52 and is a mirror thereof. The second case member 28 also includes a U-shaped recess 57 adjacent to the bottom end 56 of the slots 52. The U-shaped recess 57 extends through rearward from the front of the second case member 28.

Referring now to FIG. 9, the mobile device case 10 also comprises a shaft 58 disposed at least partially within the slots 52 of the second case member 28. The shaft 58 comprises at least one, and preferably two, tabs 60 on the ends of the shaft 58 which slide in each of the slots 52. The shaft 58 is translatable with respect to the second case member 28 and is guided by the tabs 60 along the slots 52 to adjust the location of the proximal end of a stand 62 as described below. The shaft 58 is preferably made of an elastomeric or polymeric material, but may be made of any suitable material well-known in the art. The choice of material for the shaft 58 should be made to reduce friction between the slots 52 and shaft 58 to facilitate translation of the shaft 58 along the slots 52.

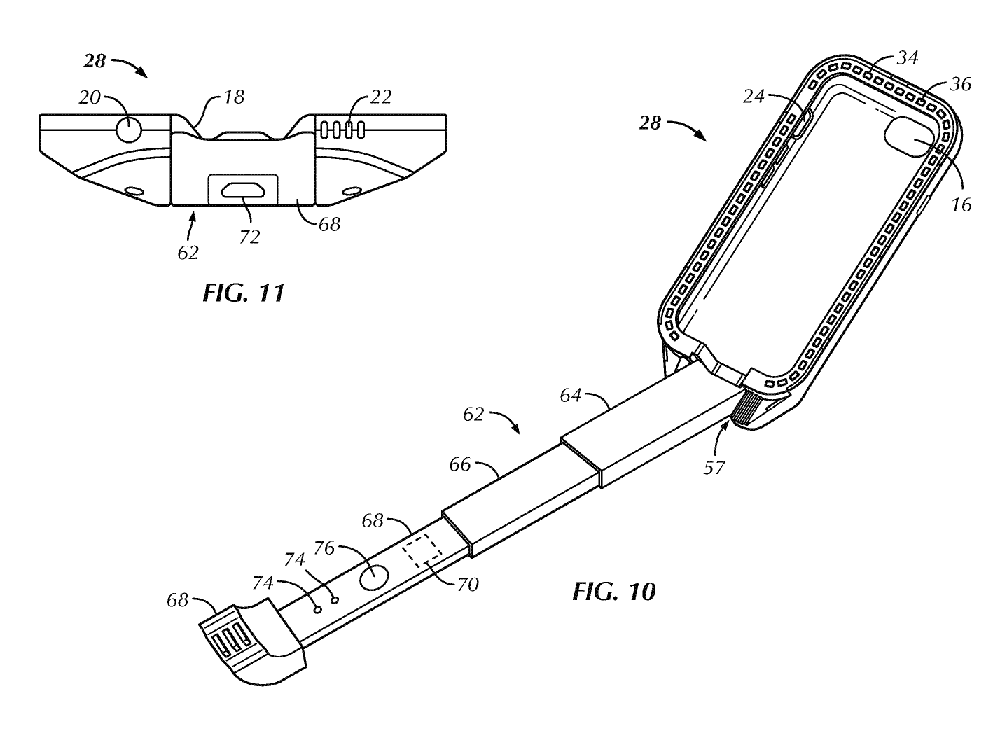

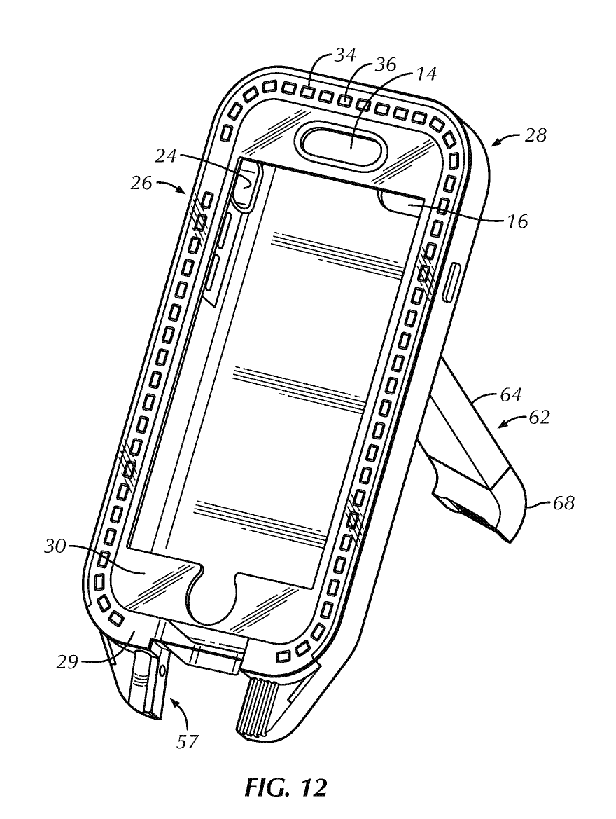

Referring now to FIGS. 10-12, the mobile device case 10 further comprises a stand 62. The stand 62 includes a rotating segment 64 which is secured on a proximal end with the shaft 58. The rotating segment 64 allows the stand 62 to rotate relative to the shaft 58, but prevents translational movement relative to the same. When the shaft 58 is disposed at the top end 54 of the slots 52 (see FIG. 12), the rotating segment 64 is capable of rotating the stand 62 up to about 90 degrees away from the second case member 28, from a stowed position (FIG. 6) to an unextended position (FIG. 12). Further, when the shaft 58 is at the bottom end 56 of the slots 52, the rotating segment 64 is capable of rotating the stand 62 up to about 80 degrees toward the first case member 26 through the U-shaped recess 57 to an extended position (FIG. 10). To transition from either a stowed or unextended position to the extended position, the user of the mobile device grasps and slides the shaft 58 and stand 62 from the top end 54 to the bottom end 56. The user may then rotate the rotating segment 64 of stand 62 toward the first case member 26 through the U-shaped recess 57.

The stand 62 further comprises at least one, and preferably more than one, telescoping segments which telescope with and are extendable from the distal end of rotating segment 64. For purposes of this application, telescoping is defined as “sliding relative to and nesting within another piece.” The rotating segment 64 is generally hollow and is dimensioned to be slightly greater than an outer dimension of a first telescoping segment 66. The stand 62 further comprises a grippable segment 68 which telescopes with and is extendable from the distal end of the telescoping segment 66. The telescoping segment 66 is generally hollow and is dimensioned to be slightly greater than an outer dimension of the grippable segment 68. The grippable segment 68 includes a grip battery 70 disposed within the grippable segment 68 (shown schematically in phantom in FIG. 10). The grippable segment 68 also includes a grip recharging port 72 in electrical contact with the grip battery 70 and which is adapted to receive a charger therein to facilitate recharging of the grip battery 70. The rotating segment 64, the telescoping segment 66, and the grippable segment 68 are preferably made of an elastomeric or polymeric material, but may be made of any suitable material well-known in the art. The grippable segment 68 also includes at least one, and preferably two, grip battery indicators 74 in electrical contact with the grip battery 70 which are configured to convey charge data about the grip battery 70 to the mobile device user. The grip battery indicators 74 are preferably LEDs, and preferably are capable of emitting first and second distinct colors to indicate the status of the grip battery 70 in the manner described above with respect to the case battery indicators 46. The grippable segment 68 also includes a toggle element 76 in electrical contact with the grip battery 70 and configured to wirelessly connect to the mobile device. Preferably, the toggle element 76 has Bluetooth wireless communication ability, though the wireless communication capability may be any suitable method well known in the art. In the present embodiment, the toggle element 76, through the Bluetooth, is configured to wirelessly communicate with the camera application of the mobile device. The toggle element 76 is configured to operate at least one function of the camera application of the mobile device such as, for example, the shutter function to permit the taking of a picture by using only the toggle element 76.

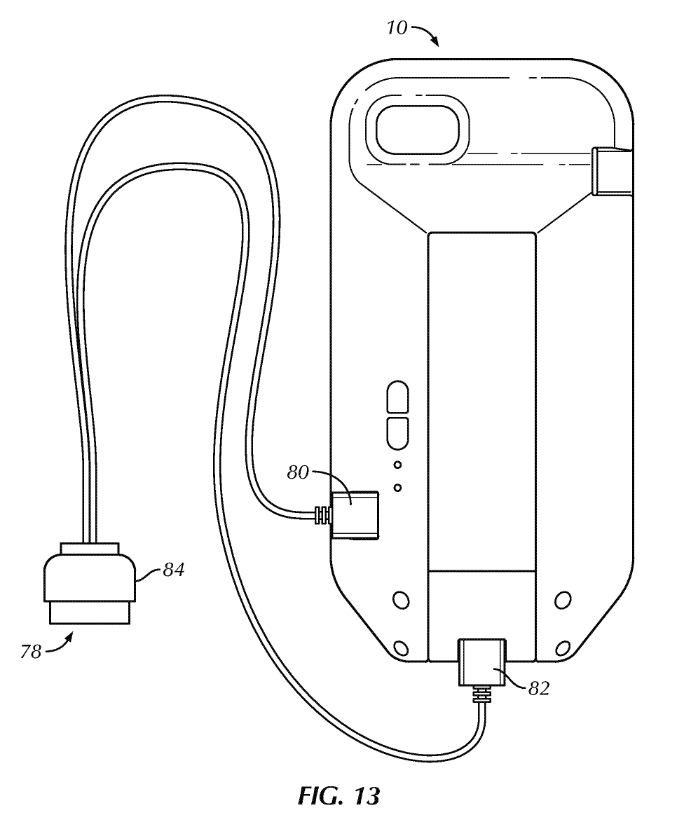

Referring now to FIG. 13, the mobile device case 10 is provided with a dual-headed charging cable 78 for recharging the case battery 38 and the grip battery 70. The charging cable 78 includes a first head 80 and a second head 82 for engaging either or both of the case recharging port 44 and grip recharging port 72 respectively. The charging cable 78 includes an adapter head 84 disposed opposite the first and second heads 80, 82. The adapter head 84 is configured to connect to an external power source and may be any well-known type of adapter, but is preferably a USB adapter. The charging cable 78 is so configured such that the case battery 38 or grip battery 70 can be charged at the same time or at separate times, while also permitting the mobile device's internal battery to be charged by the mobile device's power cable (not shown).

In operation of a preferred embodiment of the present invention, a user places the mobile device in the second case member 28 and slides the first case member 26 into latching engagement with the second case member 28 to thereby protect the mobile device from direct fall damage. The user may then utilize the mobile device as normal, or may make use of the various features provided by the present case 10. For example, the user may take a selfie while utilizing the background enhancing features of the mirror-like surface 30 and/or the lights 36. The user may power the lights 36 and select the intensity by pressing the light power on/off button 40, as described above, and may select the color of the lights 36 by repeatedly pressing the light mode button 42 until the desired setting is found. Further, a user may grab the stand 62 in the unextended position and rotate it a given angle relative to shaft 58 and second case member 28, as shown in FIG. 12. The user may then set the mobile device on a surface, acting much like a picture frame, for stability during use, such as, for example, streaming videos or taking selfies. In another alternative method of using the present invention, the user may grasp the stand 62 and slide it from the top end 54 of the slot 52 to the bottom end 56. At the bottom end 56, the user may rotate the rotating segment 64 of the stand such that the stand 62 points in the direction of the first case member 26. The user may further extend the telescoping segment 66 and grippable segment 68 away from the rotating segment 64 to move the stand to an extended position (see FIG. 10). The stand 62 may then act as a handle, such as a selfie stick, with which the user may support the mobile device at a distance from the body. Having the mobile device positioned away from the user's body facilitates such functions as the camera when a selfie is desired. The user may also activate the toggle element 76 on the grippable element 68 which cooperates with at least one corresponding function on the mobile device, such as, for example, the camera shutter function. In a preferred embodiment, the toggle element 76 wirelessly connects to the camera application of the mobile device such that when the toggle element 76 is activated, the camera function takes a picture. In another embodiment, the toggle element 76 wirelessly connects to the camera function of the mobile device as well as the lights 36 of the second case member 28. When the toggle element 76 is activated, the lights 36 provide a flash to illuminate the user as the camera function takes a picture.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A mobile device case, comprising:
a first case member having a front surface and at least one opening;
a second case member releasably engageable with the first case member, the first and second case members being dimensioned to receive a mobile device therebetween, the second case member including a case battery, a case recharging port in electrical contact with the case battery, and a slot having a top end and a bottom end;
a shaft disposed in the slot, the shaft being configured to translate relative to the slot; and
a stand rotatably attached to the shaft, the stand comprising
a rotating segment engaging the shaft,
at least one telescoping segment extendable from and nestable within the rotating segment, and
a grippable segment extending from and nestable within the at least one telescoping segment, the grippable segment comprising a toggle element wirelessly connectable to the mobile device, a grip battery for powering the toggle element, and a grip recharging port in electrical contact with the grip battery.

2. The mobile device case according to claim 1, wherein the second case member includes at least one recess and at least one light disposed within the at least one recess.

3. The mobile device case according to claim 2, wherein the at least one light is in electrical contact with a light power on/off button, wherein the light power on/off button controls the intensity and on/off state of the at least one light.

4. The mobile device case according to claim 3, wherein the at least one light is in electrical contact with a light mode button, wherein the light mode button cycles between two or more colors of the at least one light.

5. The mobile device case according to claim 1, wherein the case recharging port and grip recharging port are configured to allow charging of the case battery and grip battery respectively and independently.

6. The mobile device case according to claim 5, wherein the second case member includes at least one case battery indicator, wherein the case battery indicator illuminates a first color when the case battery is charging and illuminates a second color when the case battery is fully charged.

7. The mobile device case according to claim 5, wherein the grippable segment includes at least one grip battery indicator, wherein the grip battery indicator illuminates a first color when the grip battery is charging and illuminates a second color when the grip battery is fully charged.

8. The mobile device case according to claim 1, wherein the toggle element includes Bluetooth communication capability.

9. The mobile device case according to claim 1, wherein the stand rotates up to about 90 degrees away from the second case member at the top end of the slot.

10. The mobile device case according to claim 1, wherein the stand rotates up to about 80 degrees toward the first case member at the bottom end of the slot.

11. The mobile device case according to claim 1, wherein the second case member includes at least one recess and at least one light disposed within the at least one recess, the at least one light in electrical contact with a light power on/off button, wherein the light power on/off button controls the intensity and on/off state of the at least one light, wherein the at least one light is in electrical contact with a light mode button, wherein the light mode button cycles between two or more colors of the at least one light, wherein the case recharging port and grip recharging port are configured to allow charging of the case battery and grip battery respectively and independently, wherein the second case member includes at least one case battery indicator and the grippable segment includes at least one grip battery indicator, wherein the case battery indicators and the grip battery indicators illuminate a first color when the respective case battery or grip battery is charging and illuminate a second color when the respective case battery or grip battery is fully charged, wherein the toggle element includes Bluetooth communication capability, wherein the stand rotates about 90 degrees away from the second case member at the top end of the slot, and wherein the stand rotates about 80 degrees toward the first case member at the bottom end of the slot.

12. A kit for a mobile device case, comprising;
a mobile device case including a first case member and a second case member dimensioned to receive a mobile device therebetween and releasably engaged together, the second case member including a case battery, a case recharging port in electrical contact with the case battery and a stand, the stand including a grip battery, a grip recharging port in electrical contact with the grip battery, and a toggle element wirelessly connectable to the mobile device and powered by the grip battery; and
a dual-headed charging cable including a first head and a second head configured to engage the case recharging port and grip recharging port respectively, for charging the case battery and grip battery respectively, the charging cable also including an adapter head, disposed opposite the first and second heads, configured to engage a power source.

13. The kit for a mobile device case according to claim 12, wherein the first case member includes a front surface and at least one opening.

14. The kit for a mobile device case according to claim 12, wherein the second case member comprises at least one case battery indicator to indicate case battery status, the second case member also including at least one recess, at least one light disposed in the at least one recess and at least one slot having a top end and a bottom end.

15. The kit for a mobile device case according to claim 12, wherein the mobile device case comprises a shaft disposed in the slot and configured to translate therein.

16. The kit for a mobile device case according to claim 12, wherein the stand further comprises at least one grip battery indicator to indicate grip battery status.

17. The kit for a mobile device case according to claim 12, wherein the first case member includes a front surface and at least one opening, wherein the second case member comprises at least one case battery indicator to indicate case battery status, at least one recess, at least one light disposed in the at least one recess, and at least one slot having a top end and a bottom end, wherein the mobile device case includes a shaft disposed in the slots and configured to translate therein, and wherein the stand further comprises at least one grip battery indicator to indicate grip battery status.
